(19) United States
(12) Patent Application Publication
(10) Pub. No.: US 2004/0017279 A1
(43) Pub. Date: Jan. 29, 2004

(54) Wiring structure

(75) Inventors: Takao Kamoshima, Tokyo (JP); Junko Izumitani, Tokyo (JP); Shigeki Sunada, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: MITSUBISHI DENKI KABUSHIKI KAISHA, TOKYO (JP); Ryoden Semiconductor System Engineering Corp., Itami-shi (JP)

(21) Appl. No.: 10/349,964

(22) Filed: Jan. 24, 2003

(30) Foreign Application Priority Data
Jul. 26, 2002 (JP) 2002-217763

(51) Int. Cl. H01F 5/00

(52) U.S. Cl. 336/200

(57) ABSTRACT

The present invention protects a wiring against an etchant when a fuse connected to this wiring is subjected to a laser blow. A fuse has a barrier metal at its lower side. A plug is connected to the lower side of the fuse. The plug has a barrier metal at least at its lower side. Even if the fuse is partly removed through the laser blow at a region other than a portion where the fuse is connected to the plug, two layers of the barrier metals remain between the removed portion and a lower wiring. This enlarges the margin for preventing the adverse influence, such as corrosion and breaking of the lower wiring, brought by an etchant associated in other manufacturing process.

### BACKGROUND OF THE INVENTION

1. Field of the Invention

The present invention relates to a wiring structure applicable to a semiconductor device, for example, and a method for forming the same.

2. Description of the Background Art

A conventionally known method for compensating the defectiveness of an electric element installed in a semiconductor integrated circuit is the usage of a fuse. More specifically, the element compensation can be performed by blowing an appropriate fuse interposed between a defective element and a wiring to be connected to this element. For example, a laser beam is usable to blow the fuse. Hereinafter, this blowing is referred to as a laser blow.

When the wiring material is an aluminum alloy, a preferable material for the fuse is an aluminum alloy. When the wiring material is a copper alloy, not only the aluminum alloy but also a copper alloy is usable for the fuse.

FIG. 16 is a cross-sectional view showing a conventional fuse arrangement. A fuse 2a and a lower layer wiring 8a are embedded in an interlayer insulating film 1. In the drawing, the lower layer wiring 8a is shown as a pair of wiring portions between which the fuse 2a is connected. The interlayer insulating film 1, although shown as a whole in the drawing, has a laminated structure consisting of a plurality kinds of insulating films. In the following explanation, the wording “lower” indicates the conceptional side opposed to the wording “upper” which represents a predesignated side of a substrate to be processed for forming a semiconductor device. For example, when a groove for forming a predetermined wiring pattern are provided on one surface of the substrate, the side where the groove opens is referred to as the “upper” side compared to the bottom of the groove.

Each lower layer wiring 8a has a barrier metal 12a and a copper layer 13a. The barrier meal film 12a covers the lower and side ends of copper layer 13a and the upper end of the copper layer 13a is not covered by the barrier metal 12a. In general, the purpose of providing the barrier metal is to eliminate the mutual interference between a metallic layer and an interlayer insulating substrate or a semiconductor layer. The barrier metal can be deposited, for example, by the chemical vapor deposition (CVD) method.

The fuse 2a has two remote ends being bent downward and shows an inverted U-shaped configuration. Each remote end of the fuse 2a serves as a plug 91 extending from the upper side toward the lower side to be connected to respective lower layer wiring 8a. For example, this kind of fuse arrangement can be realized by using a dual damascene process.

The fuse 2a has a barrier metal 14a and a copper layer 15a. The barrier meal 14a covers the lower and side ends of copper layer 15a and the upper end of the copper layer 15a is not covered by the barrier metal 14a.

For example, titanium nitride or tantalum nitride can be used as a material for forming the barrier metals 12a and 14a. A preferable thickness of respective barrier metals 12a and 14a is 50 nm or less.

However, when the above-described laser blow method is applied to a flip chip type semiconductor device, there is the possibility that the process of blowing the fuse may damage the wiring portions other than the fuse.

FIG. 17 is a cross-sectional view showing a semi-finished product of a flip chip type semiconductor device. The left half to a break line of FIG. 17 is a fuse forming region in which the fuse 2a is formed. The right half to the break line of FIG. 17 is a bump forming region in which the solder bump 7 is formed.

The lower layer wiring 8a, the fuse 2a, and an upper layer wiring 2 are embedded in an interlayer insulating film 1a. The fuse 2a and the upper layer wiring 2 are formed in the same manufacturing process so that they are exposed from the uppermost surface of the interlayer insulating film 1a. For the purpose of simplifying the illustration, FIG. 17 does not distinctively show each of the barrier metal 14a and the copper layer 15a of the fuse 2a. Similarly, a barrier metal and a copper layer of the upper layer wiring 2 are not distinctively shown.

A nitride film 3, an oxide film 4, and a polyimide layer 5 are laminated in this order on the interlayer insulating film 1a. An under bump metal 6, formed in the bump forming region, extends across the nitride film 3, the oxide film 4, and the polyimide layer 5 so as to reach the upper layer wiring 2. The solder bump 7 is formed on the under bump metal 6.

In the fuse forming region, both of the oxide film 4 and the polyimide layer 5 are opened at the upper side of the fuse 2a to implement the laser blow. In general, the laser blow is a treatment for selectively removing the fuse embedded in the insulating film together with the insulating film positioned above the fuse. FIG. 17 shows a condition where the nitride film 3 and the fuse 2a are partly removed by the fuse blow treatment.

The process for forming the under bump metal 6 succeeds the laser blow. For the patterning of this, an etching of the under bump metal 6 is performed. More specifically, the etching of the under bump metal 6 is performed under the condition that the fuse 2a is exposed as a result of the laser blow. The under bump metal 6 usually has a two-layer structure consisting of a copper layer and a titanium layer. A preferable etchant for copper is a sulfurous solution, and a preferable etchant for titanium is a hydrogen peroxide solution containing hydrofluoric acid, potassium hydrate, or ammonia. The copper etchant etches the copper layer 15a exposed through the laser blow. The titanium etchant has the tendency of etching the thin barrier metal 14a of 50 nm or less. Accordingly, the copper etchant tends to reach to the plug 91 and to the lower layer wiring 8a, so that the plug 91 and the lower layer wiring 8a are adversely broken or corroded.

FIG. 18 is a cross-sectional view showing another fuse arrangement according to which a fuse 2b and an upper layer wiring 8b are embedded in an interlayer insulating film 1. In the drawing, the upper layer wiring 8b is shown as a pair of wiring portions between which the fuse 2b is connected.

Each upper layer wiring 8b has one end being bent downward so as to constitute a plug 92. The plugs 92 are connected to the remote ends of the fuse 2b. For example, this king of arrangement can be realized by using a dual damascene process. Each upper layer wiring 8b consists of a barrier metal 14b and a copper layer 15b. The barrier metal 14b covers the lower and side ends of copper layer 15b.

The fuse 2b has a barrier metal 12b and a copper layer 13b. The barrier metal 12b covers the lower and side ends of copper layer 13b and the upper end of the copper layer 13b is not covered by the barrier metal 12b.

When the fuse 2b is positioned lower than the wiring to which the fuse 2b is connected, the barrier metal 14b is thin and accordingly the fuse forming region will be also subjected to the above-described problem in the case that the laser blow treatment is applied to the fuse 2b.

### SUMMARY OF THE INVENTION

It is an object of the present invention to provide a technique, in which a wiring to be connected to a fuse is not affected by the etchant through the fuse which the laser blow is applied to.

A first wiring structure of the present invention includes a first wiring, a second wiring provided at a higher side than the first wiring, and a joint intervening between the first wiring and the second wiring configured to connect the first wiring with the second wiring. One of the first wiring and the second wiring serves as a fuse removable when subjected to a laser blow at a region other than a portion where the one of the first wiring and the second wiring is connected to the joint. The second wiring includes a main portion and a barrier metal covering a lower end of the main portion. The joint includes a barrier metal at least at its lower part.

One of the first wiring and the second wiring serves as a fuse. The fuse may be partly removed through the laser blow at the region other than the portion which is connected to the joint. In this case, however, the first wiring structure has an enlarged margin for preventing adverse influence, such as corrosion and breaking of the other of the first and second wirings, brought by an etchant associated in other manufacturing process, e.g., in another patterning process.

The second wiring structure of the present invention includes a first wiring and a second wiring provided at a higher side than the first wiring. The second wiring is connected to the first wiring. The first wiring serves as a fuse removable when subjected to a laser blow at a region other than a portion where the first wiring is connected to the second wiring. The first wiring includes a main portion and an anti-reflection film covering an upper end of the main portion. The second wiring includes a main portion and a barrier metal covering a lower end of the main portion of the second wiring.

Though the first wiring is partly removed through the laser blow at the region other than the portion where the first wiring is connected to the second wiring, two layers of the anti-reflection film and the barrier metal remain between the removed portion and the second wiring. This enlarges the margin for preventing the adverse influence, such as corrosion and breaking of the second wiring, brought by an etchant associated in other manufacturing process, e.g., in another patterning process.

The third wiring structure of the present invention includes a fuse which is embedded in an insulator and is connected to a wiring, and is partly removed at a region other than a portion where the fuse is connected to the wiring, and a coating layer covering an exposed surface of the partly removed fuse.

The coating layer covers the exposed surface of the partly removed fuse. Thus, even when an etchant is used in other manufacturing process, it is possible to prevent the etchant from corroding the wiring.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view exemplifying a wiring structure in a first embodiment of the present invention;

FIG. 2 is a cross-sectional view exemplifying another wiring structure in the first embodiment of the present invention;

FIG. 3 is a cross-sectional view exemplifying a wiring structure in a second embodiment of the present invention;

FIG. 4 is a cross-sectional view exemplifying another wiring structure in the second embodiment of the present invention;

FIGS. 5 to 7 are cross-sectional views exemplifying a wiring structure in a third embodiment of the present invention;

FIG. 8 is a cross-sectional view exemplifying another wiring structure in the third embodiment of the present invention;

FIG. 9 is a cross-sectional view exemplifying a wiring structure in a fourth embodiment of the present invention;

FIG. 10 is a cross-sectional view exemplifying another wiring structure in the fourth embodiment of the present invention;

FIG. 11 is a cross-sectional view exemplifying a wiring structure in a fifth embodiment of the present invention;

FIGS. 12 and 13 are cross-sectional views exemplifying a manufacturing step of a wiring structure in a sixth embodiment of the present invention;

FIGS. 14 and 15 are cross-sectional views exemplifying a manufacturing step of a wiring structure in a seventh embodiment of the present invention;

FIG. 16 is a cross-sectional view showing a conventional wiring structure;

FIG. 17 is a cross-sectional view explaining a problem of the conventional wiring structure; and

FIG. 18 is a cross-sectional view showing another conventional wiring structure.

### DESCRIPTION OF THE PREFERRED EMBODIMENTS

First Embodiment

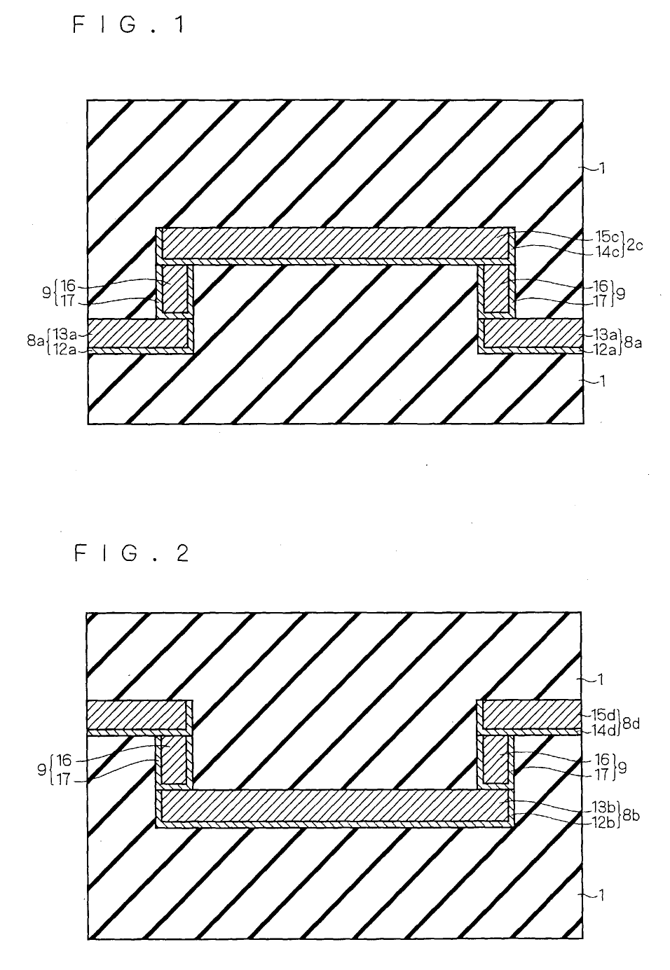

FIG. 1 is a cross-sectional view exemplifying a wiring structure in a first embodiment of the present invention. The insulating film 1a, the nitride film 3 and the oxide film 4 shown in FIG. 17 are included in an interlayer insulating film 1. The wiring structure shown in FIG. 1 is applicable to the fuse forming region shown in FIG. 17. The wiring structure shown in FIG. 1 is coexistent with the bump forming region shown in FIG. 17.

The wiring structure shown in FIG. 1 includes a lower layer wiring 8a, a fuse 2c, and a plug 9 all of which are embedded in the interlayer insulating film 1. The fuse 2c is provided at a higher side than the lower layer wiring 8a. The structure of fuse 2c can be regarded as a wiring. The fuse 2c has a copper layer 15c serving as a main portion of the fuse 2c and a barrier metal 14c covering the lower and side ends of the copper layer 15c. The upper layer wiring 2 shown in FIG. 17 and the fuse 2c are formed in the same manufacturing process.

The plug 9 is a joint intervening between the lower layer wiring 8a and the fuse 2c to provide an electric connection between them. The plug 9 has a main part 16 and a barrier metal 17 covering the lower and side ends of the main part 16.

The lower layer wiring 8a, structurally identical with the lower layer wiring explained in FIG. 16, has a copper layer 13a and a barrier metal 12a. The uppermost surface of the lower layer wiring 8a is not covered by the barrier metal 12a. The copper layer 13a is thus brought into contact with the barrier metal 17 of the plug 9.

The above-described arrangement for the lower layer wiring 8a, the fuse 2c and the plug 9 can be realized by using a single damascene process.

The fuse 2c includes the barrier metal 14c positioned at the lower part thereof. The plug 9 is connected to the bottom surface of the fuse 2c. The plug 9 includes the barrier metal 17 provided at least at the lower part thereof. Accordingly, when the fuse 2c is partly removed through the laser blow treatment at the region other than a portion where the fuse 2c is connected to the plug 9, two layers of barrier metals 14c and 17 remain between the removed portion and the copper layer 13a of the lower layer wiring 8a. This enlarges the margin for preventing the adverse influence, such as corrosion and breaking of the lower layer wiring 8a, brought by the etchant used in the patterning process for forming the under bump metal 6 (refer to FIG. 17) in the bump forming region.

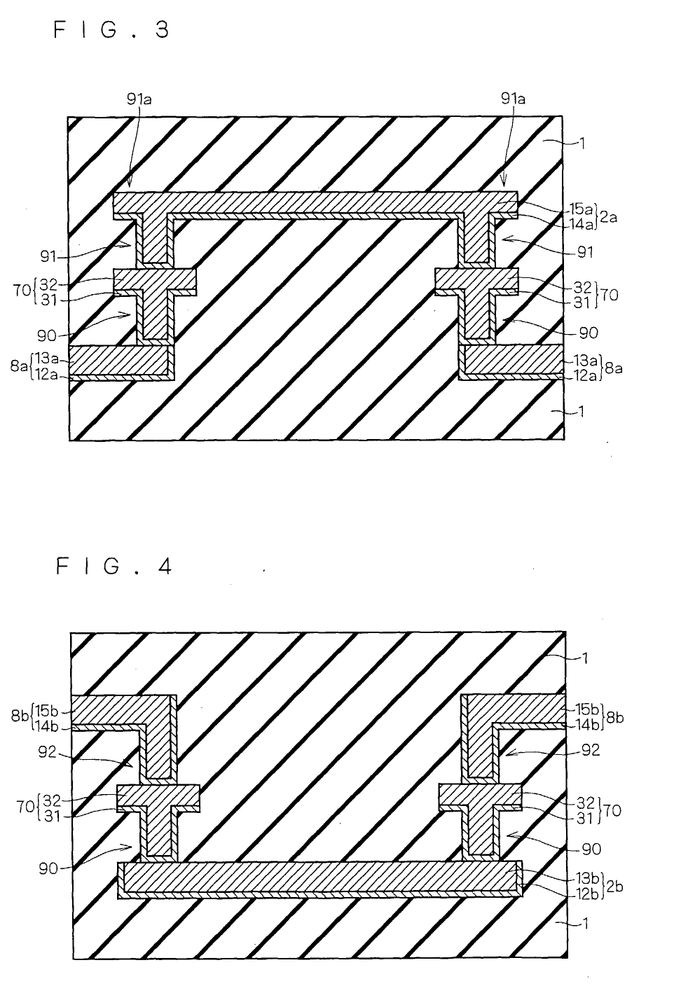

FIG. 2 is a cross-sectional view exemplifying another wiring structure in the first embodiment of the present invention. The wiring structure shown in FIG. 2 includes an upper layer wiring 8d, a fuse 2b, and a plug 9, all of which are embedded in the interlayer insulating film 1. The fuse 2b is provided at a lower side than the upper layer wiring 8d. The structure of fuse 2b can be regarded as a wiring.

The plug 9, structurally identical with the plug 9 shown in FIG. 1, is a joint intervening between the upper layer wiring 8d and the fuse 2b to provide an electric connection between them.

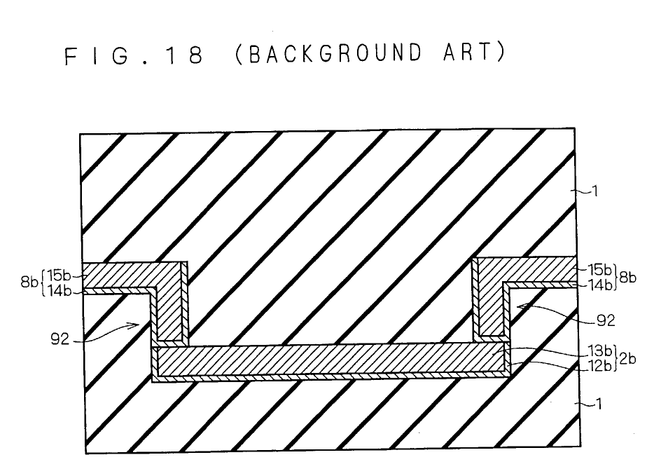

The fuse 2b, structurally identical with the fuse 2b shown in FIG. 18, has a copper layer 13b serving as a main portion of the fuse 2b and a barrier metal 12b covering the lower and side ends of the copper layer 13b. The uppermost surface of the fuse 2b is not covered by the barrier metal 12b. The copper layer 13b is thus brought into contact with the barrier metal 17 of the plug 9.

The upper layer wiring 8d has a copper layer 15d serving as a main portion thereof and a barrier metal 14d covering the lower and side ends of the copper layer 15d. The upper layer wiring 2 shown in FIG. 17 and the upper layer wiring 8d are formed in the same manufacturing process. It is possible to replace the copper layer 15d by an aluminum layer as the main portion of the upper layer wiring 8d. In this case, the main material of the upper layer wiring 2 shown in FIG. 17 is replaced by the aluminum layer.

The above-described arrangement for the upper layer wiring 8d, the fuse 2b and the plug 9 can be realized by using a single damascene process.

The upper layer wiring 8d includes the barrier metal 14d positioned at the lower part thereof. The plug 9 is connected to the bottom surface of the upper layer wiring 8d. The plug 9 includes the barrier metal 17 provided at least at the lower part thereof. Accordingly, when the fuse 2b is partly removed through the laser blow at the region other than a portion where the fuse 2b is connected to the plug 9, two layers of barrier metals 17 and 14d remain between the removed portion and the copper layer 15d of the upper layer wiring 8d. This enlarges the margin for preventing the adverse influence, such as corrosion and breaking of the upper layer wiring 8d, brought by the etchant used in the patterning process for forming the under bump metal 6 (refer to FIG. 17) in the bump forming region.

The barrier metals 12a, 12b, 14c, 14d and 17 are made of, for example, titanium nitride or tantalum nitride, and their thickness is, for example, 50 nm or less.

The material for the main part 16 of the plug 9 is selectable from the group consisting of tungsten, titanium nitride, tantalum nitride, and copper. However, to suppress the adverse influence of the etchant used in other manufacturing processes, it is preferable to select one of tungsten, titanium nitride, and tantalum nitride as the material for the main part 16 of the plug 9. In general, titanium nitride and tantalum nitride can be used for the barrier metals 17. As a whole, it is possible to form the entire part of the plug 9 by the material generally used for forming the barrier metals. The variations in the case of forming the entire part of the plug by the generally used barrier metals will be explained in the later-described third and fourth embodiments.

Second Embodiment

FIG. 3 is a cross-sectional view exemplifying a wiring structure in a second embodiment of the present invention. The wiring structure shown in FIG. 3 includes the fuse 2a and the lower layer wiring 8a explained with reference to FIG. 16 both of which are embedded in the interlayer insulating film 1. The fuse 2a shown in FIG. 3 includes an end 91a protruding in the lateral direction in addition to the downwardly extending end which serves as the plug 91. The protruding end 91a gives no specific influence to the connection between the fuse 2a and the lower layer wiring 8a.

An intermediate wiring 70 interposes between the fuse 2a and the lower layer wiring 8a. The intermediate wiring 70 is a joint connecting the lower layer wiring 8a and the fuse 2a. The intermediate wiring 70 has a main portion 32 and a barrier metal 31 covering the lower and side ends of the main portion 32. The main portion 32 is, for example, a copper layer. The material for the barrier metal 31 is, for example, titanium nitride or tantalum nitride.

The intermediate wiring 70 includes a downwardly protruding portion which serves as a plug 90. The plug 91 of the fuse 2a is brought into contact with the main portion 32 of the intermediate wiring 70. The plug 90 of the intermediate wire 70 is brought into contact with the copper layer 13a of the lower layer wiring 8a. The intermediate wiring 70 is, for example, made by using a dual damascene process.

The fuse 2a includes a barrier metal 14a positioned at the lower part thereof. The intermediate wiring 70 is connected to the bottom of the plug 91 of the fuse 2a. The intermediate wiring 70 includes the barrier metal 31 positioned at the lower part thereof. Accordingly, when the fuse 2a is partly removed through the laser blow at the region other than a portion where the fuse 2a is connected to the intermediate wiring 70, two layers of barrier metals 14a and 31 remain between the removed portion and the copper layer 13a of the lower layer wiring 8a. Providing the intermediate wiring 70 makes it possible to enlarge the distance from the fuse 2a to the lower layer wiring 8a compared with the conventional wiring structure. This enlarges the margin for preventing the adverse influence, such as corrosion and breaking of the lower layer wiring 8a, brought by the etchant used in the patterning process for forming the under bump metal 6 (refer to FIG. 17) in the bump forming region.

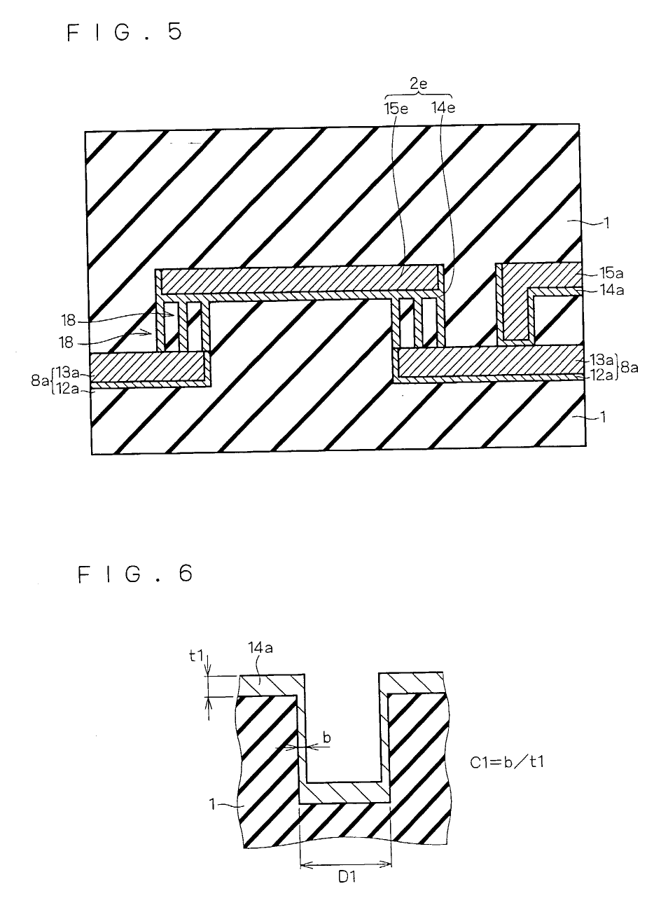

FIG. 4 is a cross-sectional view exemplifying another wiring structure in the second embodiment of the present invention. The wiring structure shown in FIG. 4 includes the fuse 2b and the upper layer wiring 8b explained with reference to FIG. 18 both of which are embedded in the interlayer insulating film 1. The upper layer wiring 8b includes an end portion being bent downward so as to constitute a plug 92.

The intermediate wiring 70, structurally identical with the one shown in FIG. 3, intervenes between the fuse 2b and the upper layer wiring 8b. The intermediate wiring 70 is a joint connecting the upper layer wiring 8a and the fuse 2b. The plug 92 of the upper layer wiring 8b is brought into contact with the main portion 32 of the intermediate wiring 70. The plug 90 of the intermediate wiring 70 is brought into contact with the copper layer 13b of the fuse 2b.

The upper layer wiring 8b includes a barrier metal 14b positioned at the lower part thereof. The intermediate wiring 70 is connected to the bottom of the plug 92. The intermediate wiring 70 includes the barrier metal 31 positioned at the lower part thereof. Accordingly, when the fuse 2b is partly removed through the laser blow at the region other than a portion where the fuse 2b is connected to the intermediate wiring 70, two layers of barrier metals 31 and 14b remain between the removed portion and the copper layer 15b of the upper layer wiring 8b. Providing the intermediate wiring 70 makes it possible to enlarge the distance from the fuse 2b to the copper layer 15b of the upper layer wiring 8b compared with the conventional wiring structure. This enlarges the margin for preventing the adverse influence, such as corrosion and breaking of the upper layer wiring 8b, brought by the etchant used in the patterning process for forming the under bump metal 6 (refer to FIG. 17) in the bump forming region.

Third Embodiment

FIG. 5 is a cross-sectional view exemplifying a wiring structure in a third embodiment of the present invention. The wiring structure shown in FIG. 5 is applicable to the fuse forming region shown in FIG. 17. The wiring structure shown in FIG. 5 is coexistent with the bump forming region shown in FIG. 17.

The wiring structure shown in FIG. 5 includes a lower layer wiring 8a, a fuse 2e, and plugs 18 all of which are embedded in an interlayer insulating film 1. The fuse 2e is provided at a higher side than the lower layer wiring 8a. The structure of fuse 2e can be regarded as a wiring. The fuse 2e has a copper layer 15e serving as a main portion of the fuse 2e and a barrier metal 14e covering the lower and side ends of the copper layer 15e. The upper layer wiring 2 shown in FIG. 17 and the fuse 2e are formed in the same manufacturing process.

Each plug 18 is a joint intervening between the lower layer wiring 8a and the fuse 2e to provide an electric connection between them. The plug 18 consists of barrier metal 14a.

The lower layer wiring 8a, as already explained, has an uppermost surface not covered by the barrier metal 12a. Accordingly, the copper layer 13a is brought into contact with the barrier metal 14e of the plug 18.

The fuse 2e having the above-described structure can be formed together with the plug 18 by using a dual damascene process. In this case, the diameter of each plug 18 is reduced so as to prevent the copper layer 15e from being formed in the plug 18. For the purpose of comparison, FIG. 5 additionally shows a double-layered plug structure employed in the ordinary dual damascene process. The double-layered plug structure shown in FIG. 5 has a copper layer 15a and a barrier metal 14a. The double-layered plug structure is shown only for convenience, and not essential for the wiring structure of the third embodiment.

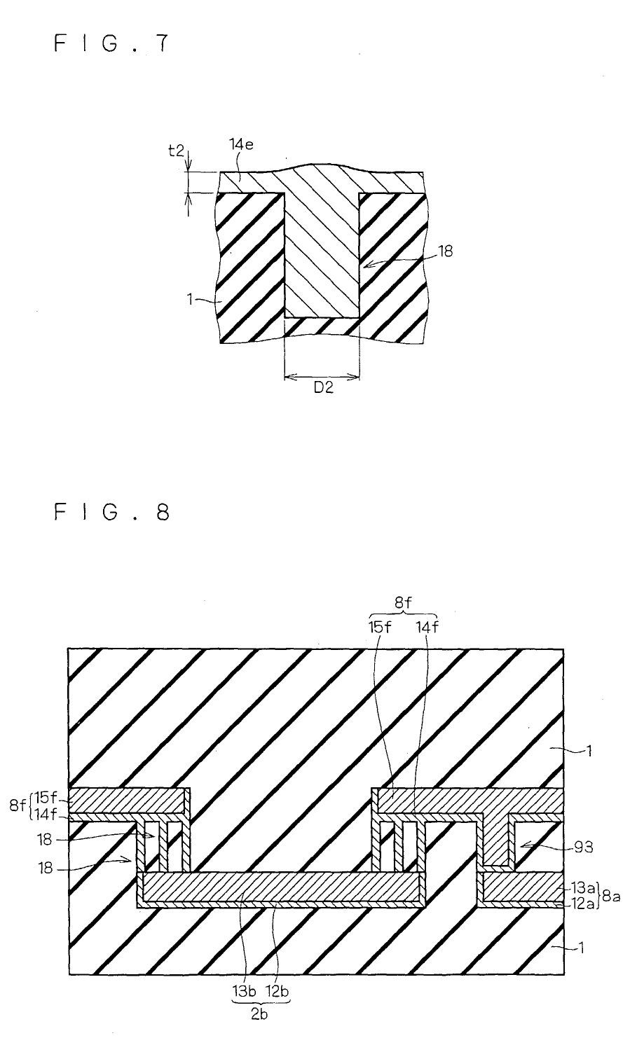

When the double-layered plug structure is formed by using the ordinary dual damascene process to leave the downwardly bent plug 9, the diameter D1 of a hole defining the plug 9 is set to be larger than 2·C1·t1, where C1 represents a side coverage and t1 represents a film thickness of the barrier metal 14a. FIG. 6 is a cross-sectional view showing the relationship of the above dimensions D1, C1, and t1. In the drawing, the symbol ‘b’ represents the thickness of the barrier metal 14a formed along the side wall of the hole. With this setting, it becomes possible to leave a recessed portion inside the hole.

On the other hand, the diameter D2 of a hole defining the plug 18 is set to be smaller than 2·C2·t2, where C2 represents a side coverage and t2 represents a film thickness of the barrier metal 14e. FIG. 7 is a cross-sectional view showing the relationship of the above dimensions D2, C2, and t2. With this setting, the hole is filled with the barrier metal 14e which serves as the plug 18.

As described above, the third embodiment provides the plugs 18 intervening between the fuse 2e and the lower layer wiring 8a. When the fuse 2e is partly removed through the laser blow at the region other than a portion where the fuse 2e is connected to the plugs 18, the thick barrier metals 14e remains between the removed portion and the copper layer 13a of the lower layer wiring 8a. This enlarges the margin for preventing the adverse influence, such as corrosion and breaking of the lower layer wiring 8a, brought by the etchant used in the patterning process for forming the under bump metal 6 (refer to FIG. 17) in the bump forming region.

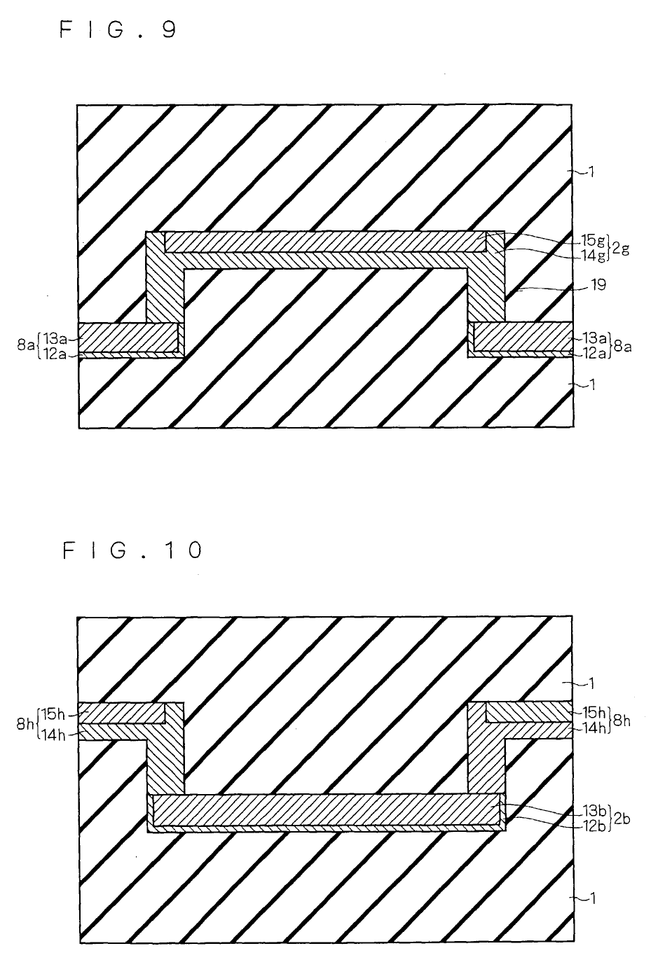

FIG. 8 is a cross-sectional view exemplifying another wiring structure in the third embodiment of the present invention. The wiring structure shown in FIG. 8 includes an upper layer wiring 8f, a fuse 2b, and plugs 18 all of which are embedded in an interlayer insulating film 1. The fuse 2b is provided at a lower side than the upper layer wiring 8f. The structure of fuse 2b can be regarded as a wiring. The plugs 18, structurally identical with those shown in FIG. 5, is a joint intervening between the upper layer wiring 8f and the fuse 2b to provide an electric connection between them.

In this case, the diameter of each plug 18 is reduced so as to prevent the copper layer 15f from being formed in the plug 18. For the purpose of comparison, FIG. 8 additionally shows a double-layered plug 93 employed in the ordinary dual damascene process. The double-layered plug 93 shown in FIG. 8 has the copper layer 15f and a barrier metal 14f. The double-layered plug 93 is shown only for convenience, and not essential for the wiring structure of the third embodiment.

The upper layer wiring 8f has the copper layer 15f serving as a main portion thereof and the barrier metal 14f covering the lower and side end of the copper layer 15f. The upper layer wiring 2 shown in FIG. 17 and the upper layer wiring 8f are formed in the same manufacturing process. It is possible to replace the copper layer 15f by an aluminum layer as the main portion of the upper layer wiring 8f. In this case, the main material of the upper layer wiring 2 shown in FIG. 17 is replaced by the aluminum layer.

The fuse 2b, whose structure is already described, has a copper layer 13b which contacts with the barrier metal 14f of the plug 18.

The above-described arrangement for the upper layer wiring 8f and the plugs 18 is realized by using a dual damascene process.

As described above, the plugs 18 intervene between the fuse 2b and the upper layer wiring 8f. When the fuse 2b is partly removed through the laser blow at the region other than a portion where the fuse 2b is connected to the plugs 18, the thick barrier metals 14f remains between the removed portion and the copper layer 15f of the upper layer wiring 8f. This enlarges the margin for preventing the adverse influence, such as corrosion and breaking of the upper layer wiring 8f, brought by the etchant used in the patterning process for forming the under bump metal 6 (refer to FIG. 17) in the bump forming region.

As each plug 18 has a thin diameter, it is preferable to provide a plurality of plugs 18 at one connecting portion between the fuse 2e and the lower layer wiring 8a as shown in FIG. 5 to reduce the overall electric resistance at this connecting portion. Similarly, it is preferable to provide a plurality of plugs 18 at one connecting portion between the fuse 2b and the upper layer wiring 8f as shown in FIG. 8.

Fourth Embodiment

FIG. 9 is a cross-sectional view exemplifying a wiring structure in a fourth embodiment of the present invention. The wiring structure shown in FIG. 9 is applicable to the fuse forming region shown in FIG. 17. The wiring structure shown in FIG. 9 is coexistent with the bump forming region shown in FIG. 17.

The wiring structure shown in FIG. 9 includes a lower layer wiring 8a, a fuse 2g, and a plug 19 all of which are embedded in an interlayer insulating film 1. The fuse 2g is provided at a higher side than the lower layer wiring 8a. The structure of fuse 2g can be regarded as a wiring. The fuse 2g has of a copper layer 15g serving as a main portion of the fuse 2g and a barrier metal 14g covering the lower and side ends of the copper layer 15g. The upper layer wiring 2 shown in FIG. 17 and the fuse 2g are formed in the same manufacturing process. The plug 19 is a joint intervening between the lower layer wiring 8a and the fuse 2g to provide an electric connection between them. The plug 19 consists of the barrier metal 14g.

The lower layer wiring 8a, as already explained, has an uppermost surface not covered by the barrier metal 12a. Accordingly, the copper layer 13a is brought into contact with the barrier metal 14g of the plug 19.

The fuse 2g having the above-described structure can be formed together with the plug 19 by using a dual damascene process. In this case, the thickness of the plug 19 (i.e., the thickness of barrier metal 14g) is increased so as to prevent the copper layer 15g from being formed in the plug 19. To this end, the thickness of the barrier metal 14g is set to be larger than D3/(2·C3) where C3 represents a side coverage and D3 represents a diameter of the plug 19. The diameter of plug 19 is different from the diameter of plug 18 in that the plug 19 can be thickened to the level equivalent to the conventional plug 9. Thus, it is not necessary to provide a plurality of plugs 18 arranged in parallel with each other.

As described above, the plug 19 intervenes between the fuse 2g and the lower layer wiring 8a. When the fuse 2g is partly removed through the laser blow at the region other than a portion where the fuse 2g is connected to the plug 19, the thick barrier metal 14g remains between the removed portion and the copper layer 13a of the lower layer wiring 8a. This enlarges the margin for preventing the adverse influence, such as corrosion and breaking of the lower layer wiring 8a, brought by the etchant used in the patterning process for forming the under bump metal 6 (refer to FIG. 17) in the bump forming region.

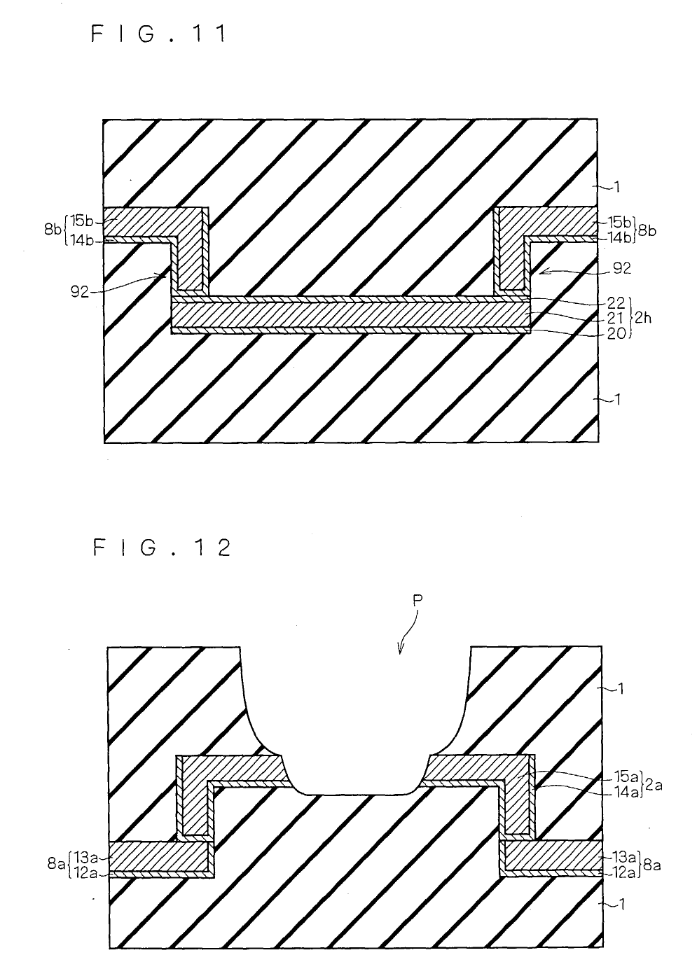

FIG. 10 is a cross-sectional view exemplifying another wiring structure in the fourth embodiment of the present invention. The wiring structure shown in FIG. 10 includes an upper layer wiring 8h, a fuse 2b, and a plug 19 all of which are embedded in an interlayer insulating film 1. The fuse 2b is provided at a lower side than the upper layer wiring 8h. The structure of fuse 2b can be regarded as a wiring. The plug 19, structurally identical with the one shown in FIG. 9, is a joint intervening between the upper layer wiring 8h and the fuse 2b to provide an electric connection between them.

The upper layer wiring 8h has a copper layer 15h serving as a main portion thereof and the barrier metal 14h covering the lower and side ends of the copper layer 15h. The upper layer wiring 2 shown in FIG. 17 and the upper layer wiring 8h are formed in the same manufacturing process. It is possible to replace the copper layer 15h by an aluminum layer as the main portion of the upper layer wiring 8h. In this case, the main material of the upper layer wiring 2 shown in FIG. 17 is replaced by the aluminum layer.

The fuse 2b, whose structure is already described, has a copper layer 13b which contacts with the barrier metal 14h of the plug 19.

The above-described arrangement for the upper layer wiring 8h and the plug 19 is realized by using a dual damascene process.

As described above, the plug 19 intervenes between the fuse 2b and the upper layer wiring 8h. When the fuse 2b is partly removed through the laser blow at the region other than a portion where the fuse 2b is connected to the plug 19, the thick barrier metal 14h remains between the removed portion and the copper layer 15h of the upper layer wiring 8f. This enlarges the margin for preventing the adverse influence, such as corrosion and breaking of the upper layer wiring 8h, brought by the etchant used in the patterning process for forming the under bump metal 6 (refer to FIG. 17) in the bump forming region.

### Fifth Embodiment

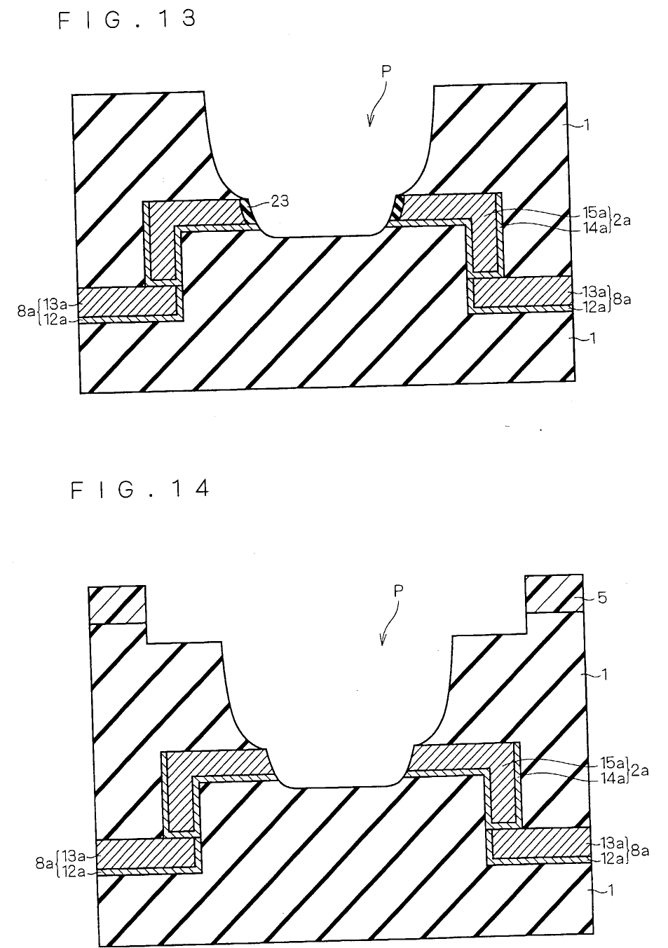

FIG. 11 is a cross-sectional view exemplifying a wiring structure in a fifth embodiment of the present invention. The wiring structure shown in FIG. 11 includes an upper layer wiring 8b and a fuse 2h both of which are embedded in an interlayer insulating film 1. In the drawing, the upper layer wiring 8b is shown as a pair of wring portions between which the fuse 2h is connected. The fuse 2h is provided at a lower side than the upper layer wiring 8b. The fuse 2h can be regarded as a wiring.

Each upper layer wiring 8b has one end being bent downward so as to constitute a plug 92. The plugs 92 are connected to the remote ends of the fuse 2h. The upper layer wiring 8b includes a barrier metal 14b and a copper layer 15b serving as a main portion thereof. The barrier metal 14b covers the lower and side ends of the copper layer 15b, and the upper end of the copper layer 15b is not covered by the barrier metal 14b. The above-described arrangement can be realized by using a dual damascene process.

The fuse 2h includes a barrier metal 20, an aluminum layer 21, and an anti-reflection film 22. The barrier metal 20 covers a lower end of the aluminum layer 21. The anti-reflection film 22 covers an upper end of the aluminum layer 21. The provision of anti-reflection film 22 improves the patterning of the wiring or the interlayer insulating film positioned higher than the aluminum layer 21. More specifically, the aluminum layer 21 reflects an exposure light employed in the photolithography technology. This deteriorates the dimensional accuracy of the photoresist. The anti-reflection film 22 eliminates such drawbacks. For example, the anti-reflection film 22 is a double-layer structure having a titanium nitride layer and a titanium layer.

When the fuse 2h is partly removed through the laser blow at the region other than a portion where the fuse 2h is connected to the plug 92, two layers of the anti-reflection film 22 and the barrier metal 14b remain between the removed portion and the copper layer 15b of the upper layer wiring 8b. This enlarges the margin for preventing the adverse influence, such as corrosion and breaking of the upper layer wiring 8b, brought by the etchant used in the patterning process for forming the under bump metal 6 (refer to FIG. 17) in the bump forming region.

Sixth Embodiment

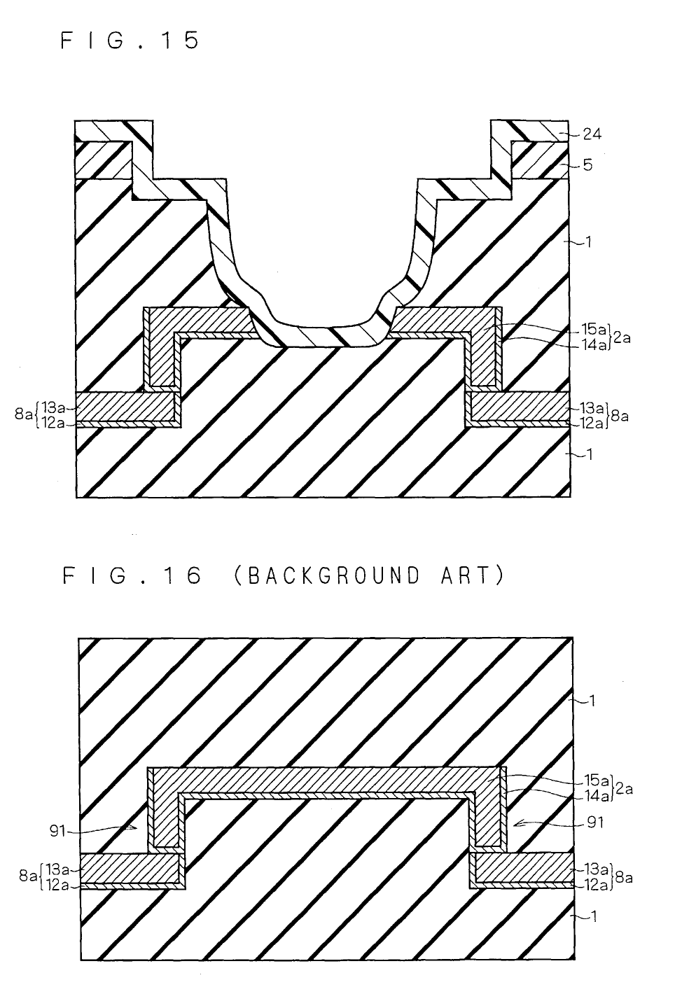

FIGS. 12 and 13 are cross-sectional views exemplifying a method for manufacturing the wiring arrangement in a sixth embodiment of the present invention.

FIG. 12 shows a condition of immediately after the laser blow is applied to the wiring structure shown in FIG. 16. The laser blow leaves an opening P where the copper layer 15a is partly exposed. If this condition of the wiring structure is subjected to the etching for patterning the under bump metal 6 shown in FIG. 17, the lower layer wiring 8a will encounter with the above-described corrosion.

Hence, the sixth embodiment adds a process for forming a denatured layer 23 by denaturing the surface of the copper layer 15a exposed to the opening P (see FIG. 13), prior to the application of an etchant for copper in the succeeding process. For example, a plasma treatment using a nitrogen gas or an ammonia is applied on the surface of copper layer 15a exposed to the opening P. As a result of this plasma treatment, the exposed surface of copper layer 15a turns into a copper nitride serving as the denatured layer 23. Alternatively, a plasma treatment using an oxygen gas is applied to the surface of copper layer 15a exposed to the opening P. In this case, the exposed surface of copper layer 15a turns into a copper oxide serving as the denatured layer 23.

The denatured layer 23 thus formed covers the surface of the copper layer 15a exposed to the opening P. Accordingly, even if an etchant for copper is used in the succeeding process, the copper layer 15a and the lower layer wiring 8a are protected against the corrosion of etchant.

Seventh Embodiment

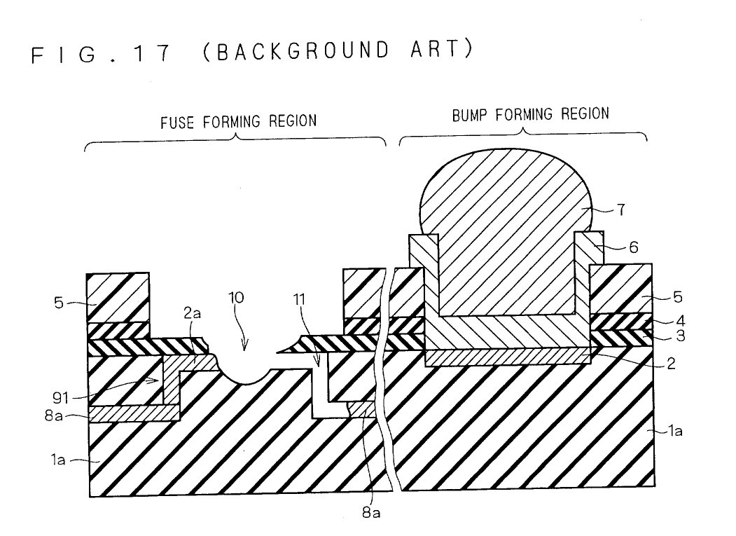

FIGS. 14 and 15 are cross-sectional views exemplifying a method for manufacturing the wiring arrangement in a seventh embodiment of the present invention.

FIG. 14 shows a condition immediately after the laser blow is applied to the wiring structure shown in FIG. 16. FIG. 14 differs from FIG. 12 in that a polyimide layer 5 is explicitly shown. Like FIG. 12, the copper layer 15a is partly exposed to the opening P left as a result of the laser blow. If this condition of the wiring structure is subjected to the etching for patterning the under bump metal 6 shown in FIG. 17, the lower layer wiring 8a will encounter with the above-described corrosion.

Hence, the seventh embodiment adds a process for forming a polyimide layer 24 as a coating film covering the fuse 2a exposed to the opening P as well as the interlayer insulating film 1 (see FIG. 15), prior to the application of an etchant for copper in the succeeding process. It is, of course, possible to make the polyimide layer 24 cover at least the exposed surface of the fuse 2a. Accordingly, even if an etchant for copper is used in the succeeding process, the copper layer 15a and the lower layer wiring 8a are protected against the corrosion of etchant.

As the patterning is feasible on the polyimide film 24, it can be selectively removed at other portion while it closes the opening P. Instead of using the polyimide film 24, it is possible to use a plasma oxide film serving as a coating film.

While the invention has been shown and described in detail, the foregoing description is in all aspects illustrative and not restrictive. It is therefore understood that numerous other modifications and variations can be devised without departing from the scope of the invention.

What is claimed is:

1. A wiring structure comprising:
a first wiring;
a second wiring provided at a higher side than said first wiring; and
a joint intervening between said first wiring and said second wiring configured to connect said first wiring with said second wiring, wherein
said second wiring comprises a main portion and a barrier metal covering a lower end of said main portion, and
one of said first wiring and said second wiring serves as a fuse removable when subjected to a laser blow at a region other than a portion where said one of said first wiring and said second wiring is connected to said joint.

2. The wiring structure according to claim 1, wherein said joint is configured as a plug.

3. The wiring structure according to claim 2, wherein a hole defining said plug has a diameter larger than twice a product of a side coverage and a film thickness of said barrier metal.

4. The wiring structure according to claim 2, wherein said second wiring serves as said fuse.

5. The wiring structure according to claim 2, wherein said first wiring serves as said fuse.

6. The wiring structure according to claim 1, wherein said joint is provided as a third wiring.

7. The wiring structure according to claim 6, wherein said second wiring serves as said fuse.

8. The wiring structure according to claim 6, wherein said first wiring serves as said fuse.

9. The wiring structure according to claim 1, wherein said joint is made of the barrier metal.

10. The wiring structure according to claim 9, wherein said joint is configured so as to constitute at least one plug.

11. The wiring structure according to claim 10, wherein a hole defining said plug has a diameter smaller than twice a product of a side coverage and a film thickness of said barrier metal.

12. The wiring structure according to claim 10, wherein said joint is configured as a plurality of plugs.

13. The wiring structure according to claim 12, wherein said second wiring serves as said fuse.

14. The wiring structure according to claim 12, wherein said first wiring serves as said fuse.

15. The wiring structure according to claim 10, wherein said joint is constituted by said barrier metal of said second wiring.

16. The wiring structure according to claim 15, wherein said second wiring serves as said fuse.

17. The wiring structure according to claim 15, wherein said first wiring serves as said fuse.

18. A wiring structure comprising:
a first wiring;
a second wiring provided at a higher side than said first wiring, said second wiring being connected to said first wiring, wherein
said first wiring comprises a main portion and an anti-reflection film covering an upper end of said main portion,
said second wiring comprising a main portion and a barrier metal covering a lower end of said main portion of the second wiring, and
said first wiring serves as a fuse removable when subjected to a laser blow at a region other than a portion where said first wiring is connected to said second wiring.

19. A wiring structure comprising:
a fuse which is embedded in an insulator and is connected to a wiring, and is partly removed at a region other than a portion where said fuse is connected to said wiring, and
a coating layer covering an exposed surface of the partly removed fuse.

20. The wiring structure according to claim 19, wherein said coating layer is a denatured layer obtained by denaturing said exposed surface of the partly removed fuse.
